(19) United States
(12) Patent Application Publication
(10) Pub. No.: US 2004/0203720 A1
(43) Pub. Date: Oct. 14, 2004

(54) Personal communication device with transmitted RF power strength indicator and warning system

(75) Inventors: Did-Min Shih, Milpitas, CA (US); Chun-Chieh Chen, Taipei (TW); Jyhfong Lin, Taipei (TW); Peir-Weir Chen, Taipei (TW)

Correspondence Address: RABIN & Berdo, PC, 1101 14TH STREET, NW, SUITE 500, WASHINGTON, DC, 20005, US

(73) Assignee: VIA TECHNOLOGIES, INC.

(21) Appl. No.: 10/223,246

(22) Filed: Aug. 20, 2002

(51) Int. Cl. H04B 17/00; H04Q 7/20

(52) U.S. Cl. 455/423; 455/67.11

(57) ABSTRACT

The present invention provide a radio communication device having a transmitter for emitting a radio signal to a corresponding receiver comprise an indicating means and a controller; wherein the indicating means for indicating a transmitted RF power strength status of the transmitter; the controller for detecting and outputting the transmitted power strength status to the indicating means, the controller including a power detecting means; wherein the power detecting means coupled to the transmitter for detecting a transmitted power level of the radio signal emitted from a transmitter to a corresponding receiver.

### BACKGROUND OF THE INVENTION

1. Field of the Invention

The present invention relates generally to radio communication systems, and more particularly, to a PCD (Personal Communication Device) and a method for indicating the transmitted RF power strength level in a radio communication terminal by outputting power strength level of a transmitter of the radio communication terminal to an indicating device.

2. Description of the Prior Art

AMPS, PHS, NADC, GSM, DCS, PCS, IS-95, CDMA, WCDMA, DECT, WLAN (802.11), DECT, CT0, CT1, . . . etc. are well known standards for wireless network and PCDs (personal communication devices). Personal communication devices include cellular phone, cordless phone, PDA, walkie-talkie, smart phone and others. All personal communication device mentioned above are wireless communication devices (or radio communication devices). Communication links among PCDs are established through receiving and transmitted radio-frequency signal. The frequency range of these radio frequency covers from VHF to microwave frequency. In order to extend the communication range, PCDs can transmit RF signal up to two Watts.

A personal communication device such as cellular phone can be seen generally as depicted in FIG. 1, it consists of a RF (Radio Frequency) receiver Section 14, a RF Transmit Section 18, a Frequency Synthesizer 146-186, a Digital/Controller Section 15, a Battery (not shown) and a I/O Section (not shown) etc.

One example of the PCD as shown in FIG. 1 is a cellular phone handset which complied with the standards above. The handset 1 includes an antenna 11, a LPF (low pass filter) 12, a receiver (RX) 14, a LPF 16, a transmitter (TX) 18 and a digital/controller 15, wherein the receiver (RX) 14 includes a PA (power amplifier) 142, a mixer 144 and a frequency synthesizer 146. similarly, the transmitter (TX) 18 includes an power amplifier 182, a mixer 124 and a synthesizer 186 an modulator 188.

When cellular phone handset is used, it is a very common practice for user to have handset very close to their head in order to talk and to listen. The handset radiates RF (Radio Frequency) signal into air to establish communication link to a base station. But, the transmitted RF signal is not only radiate to air but also radiate and penetrate to the user's head. Some scientific studies showed that long-term expose under the RF signal radiation, it could damage human tissue. One IEEE paper proposed by M. D. Taurisano etc., the tittle of the paper is “Measurements of Thermal Effects on a Human Head exposed to 900 MHz”, presented on IEEE MTT Symposium 2000, Boston., presented results of experiments concerning thermal effects due to electromagnetic exposure from handheld mobile communication equipment.

Today, personal communication device such as cellular phone handset, cordless phone etc. provided user some information such as RSSI (received signal strength indication) (for example, U.S. Pat. No. 6,356,745 disclose the RSSI), battery low signal and battery charge status etc., but none of them provides TSSI (transmitted signal strength indication) (or called transmitted power indication) to the users for warning the high transmitted power state about their handset.

Also the cellular phone's TSS (transmitted signal strength) is not a constant, how much RF power the cellular phone handset could transmit is subject to the specific regulations and base station instruction. It means the base station will tell the handset how much RF power handset could transmit.

Base station's instruction depends on the communication environmental conditions such as distance, surrounding building and terrain etc. between the cellular phone and the base station. The cellular phone user has no idea how the TSS (transmitted signal strength) of cellular phone is.

Because scientific studies showed that long-term expose to RF signal, it can damage human tissues. Therefore there is a need in the prior art for PCD which can inform the PCD (Personal Communication Device) users how much the TSS (transmitted signal strength) is. Thus the PCD users can make some action to reduce the damage to their tissues from such TSS information.

### SUMMARY OF THE INVENTION

It is an objective of the present invention to the transmitted RF signal power status, user-programmable warning signal in a form of sound, vibration or voice, and user-programmable when PCD gives warning signal for the PCDs' users. With such information, PCD user can adjust PCD position or change communication location to reduce PCD's radiated RF power or shorten the talk time to reduce the exposure time to RF radiation.

On the other words, the PCD of the present invention provides a TSSI (transmitted RF power strength indication) and a warning system for the PCDs' user. With such information, PCD user can adjust PCD position or change communication location to reduce PCD's radiated RF power or shorten the talk time to reduce the exposure time to RF radiation.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a block diagram of the PCD in the prior art.

FIG. 2 is a block diagram of the first embodiment of the PCD with a transmitted RF power strength indicating circuit in the present invention.

FIG. 3 is a block diagram of the second embodiment of the PCD with a transmitted RF power strength indicator in the present invention.

FIG. 4 is a graph of relationship between TSS level and the transmitted signal RF power strength.

FIG. 5 is a graph of setting a warning level for the transmitted RF power strength of the third embodiment in the present invention.

FIG. 6 is a flow chart for indicating a transmitted RF power strength of the third embodiment in the present invention.

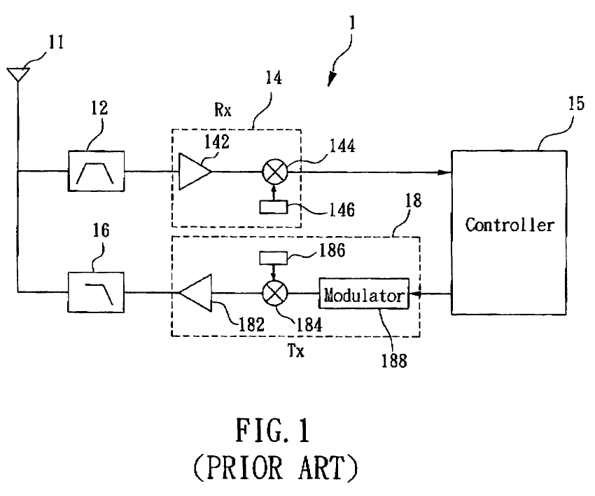

### DETAILED DESCRIPTION OF THE INVENTION

First embodiment

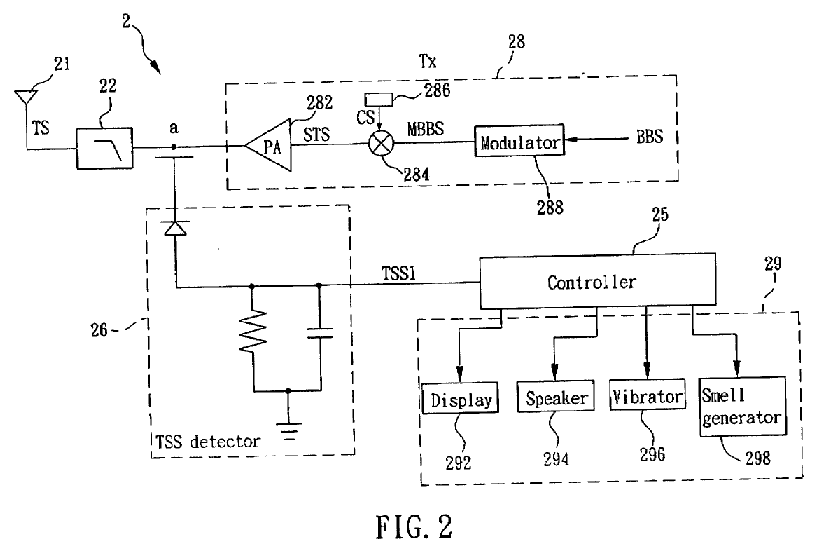

FIG. 2 is a block diagram of the first embodiment of the PCD with a transmitted RF power strength indicating circuit in the present invention. Transmit section 28 can be seen generally as depicted in FIG. 2, it included modulator (or called modulator) 288, power amplifier 282 and transmitted RF power detector 26. The transmitted baseband signal BBS is modulated at modulation section 288, the output signal of modulation section MBBS is further processed then connected to the power amplifier 282 or connected to the power amplifier 282 directly. The power amplifier output signal is connected to filter 22, RF switch then connected to antenna 21, then radiate the transmitted signal. The transmitted RF power detector (or called transmitted signal strength detector) is used to detect TSS (transmitted signal strength).

In other words, the PCD 2 of the present invention mainly comprises a RF transmitter (TX) 28, a TSS detector 26 and a Digital/controller 25 and an indicating means 29 and a Battery (not shown) etc., wherein the transmitter (TX) 28 includes a PA (power amplifier) 282, a mixer 284, a modulator 288 and a frequency synthesizer (or called a local oscillator) 286.

When a base band signal BBS want to be transmitted, first the base band signal BBS will be transmitted to the modulator 288, and generated a modulated BBS signal MBBS. The mixer 284 receives the modulated BBS signal MBBS and the carrier signal CS from the frequency synthesizer 286, then implements signal multiplication of them, and generated a semi-transmission signal STS. The semi-transmission signal STS is further amplified by the power amplifier 282 and filtered by a low pass filter 22, then a transmission signal TS is transmitted by the antenna 21.

In the present invention, the TSS detector 26 is coupled to the point a disposed between low pass filter 22 and the power amplifier 282. When a transmission signal TS is transmitted by the antenna 21, the TSS detector 26 will generate a TSS level signal for determining the transmitted RF power from the power amplifier and transmitted the TSS level signal to the controller 25. Finally, the controller will output the TSS level information to a indicator (or called a indicating means) 29 for indicating the transmitted RF power strength of the PCD 2.

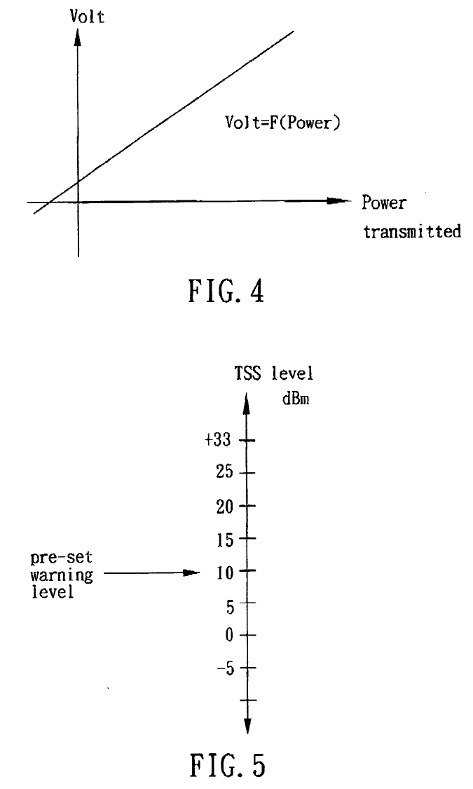

Originally what the TSS detector 26 detected is a voltage signal TSSI, we can obtain a transmitted power value by the function relationship between the transmitted voltage and the transmitted RF power of the transmitter as shown in FIG. 4. That is to say, we can also convert the TSS value into a dBm value by the following formula:

Power dBm=10 log[Power_{transmitted}÷1 m Watt] equation (1)

In other words, the present invention provide a radio communication device having a transmitter for emitting a radio signal to a corresponding receiver comprise an indicating means and a controller; wherein the indicating means for indicating a transmitted RF power strength status (or called TSSI (transmitted signal strength indication)) of the transmitter; the controller for detecting and outputting the transmitted power strength status to the indicating means, the controller including a power detecting means; wherein the power detecting means coupled to the transmitter for detecting a TSS (transmitted Signal Strength) level of the radio signal emitted from a transmitter to the corresponding receiver.

Wherein the power detecting means further comprises a TSS detector coupled to a point of a conducting line disposed between a low pass filter coupled to a antenna of the radio communication device and a power amplifier of the transmitter for detecting the TSS level of the radio signal of the transmitter, and output the detecting result to the controller.

Wherein the TSS detector further comprises a RC oscillation circuit coupled to a diode for detecting the TSS level of the radio signal of the transmitter.

Wherein the indicating means can be a display for displaying the TSS level, a speaker for indicating the TSS level by sounds or voices, a vibrator for indicating the TSS level by vibration or a smell generator for indicating the TSS level by a smell.

Second embodiment

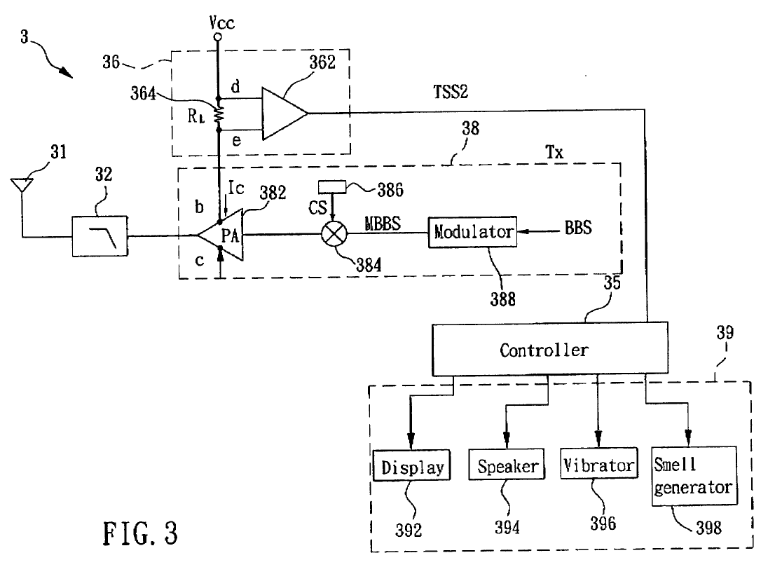

FIG. 3 is a block diagram of the second embodiment of the PCD with a transmitted RF power strength indicating circuit in the present invention. The transmitted signal strength TSS can be determined by sensing PA's (Power amplifier 382) dc current consumption or sensing RF signal power directly as shown in FIG. 3.

Transmit section 38 can be seen generally as depicted in FIG. 3, it included modulator (or called modulator) 388, power amplifier 382 and transmitted RF power detector 36. The transmitted baseband signal BBS is modulated at modulation section 388, the output signal of modulation section MBBS is further processed then connected to the power amplifier 382 or connected to the power amplifier 382 directly. The power amplifier output signal is connected to filter 32, RF switch then connected to antenna 31, then radiate the transmitted signal. The transmitted RF power detector (or called transmitted signal strength detector) is used to detect the TSS (transmitted signal strength) level.

Once the TSS is detected, the detection result TSS2 will be sent to the controller 35, the controller will display the TSS status in LCD or LED and deliver a user-programmable warning signal in a form of sound, vibration, light or voice etc. to the PCD user. It is also user-programmable when PCD give warning signal.

With the TSS status information, the PCD user can adjust their PCD position or change communication location to reduce the tissue absorption of PCD's radiated RF power or shorten the talk time to reduce the exposure time of the RF radiation.

The second embodiment is similar to the first embodiment except the TSS detector 36.

The TSS detector 36 coupled to a power amplifier 382 for detecting the DC offset of the power amplifier 382 of the transmitter 38, and output the detecting result to the controller 35.

Wherein the TSS detector further comprises a resistor R_{L} with one terminal coupled to the power amplifier 382 and a operational amplifier 362 with two input terminal coupled to the two terminal of the resistor R_{L} respectively for determining the DC voltage difference between the two terminal of the resistor. What the TSS detector 36 detected on the point b is a voltage signal which is converted by a current signal Ic from the power amplifier 382. Because there is a relationship between the current Ic and the transmitted power consumption, thus we can know the transmitted signal power strength.

In other words, the present invention provide a radio communication device having a transmitter for emitting a radio signal to a corresponding receiver comprise an indicating means and a controller, wherein the indicating means for indicating a transmitted RF power strength status (or called TSSI (transmitted signal strength indication)) of the transmitter, the controller for detecting and outputting the transmitted power strength status to the indicating means, the controller including a power detecting means; wherein the power detecting means coupled to the transmitter for detecting a TSS (transmitted Signal Strength) level of the radio signal emitted from a transmitter to the corresponding receiver.

Wherein the power detecting means further comprises a TSS detector coupled to a power amplifier of the transmitter for detecting a DC offset of the power amplifier of the transmitter corresponding to the TSS (transmitted signal strength) of the transmitter.

Wherein in the second embodiment of the present invention the TSS detector further comprises a resistor coupled to the operation amplifier having two terminals, the resistor have two terminals, one terminal of the resistor coupled to the power amplifier and one terminal of the operational amplifier, the other terminal of the resistor coupled to the other terminal of the operational amplifier and a power voltage source for determining the DC voltage difference between the two terminal of the resistor corresponding to the TSS (transmitted signal strength)

Wherein the indicating means can be a display for displaying the TSS level, a speaker for indicating the TSS level by sounds or voices, a vibrator for indicating the TSS level by vibration or a smell generator for indicating the TSS level by a smell.

Third embodiment

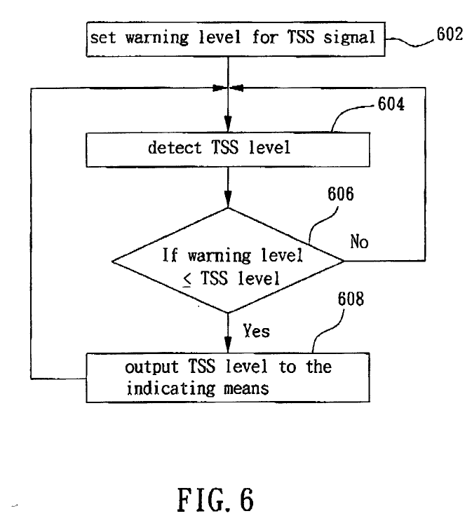

FIG. 6 is a flow chart for indicating a transmitted RF power strength of the third embodiment in the present invention. The present provide a method to indicating a transmitted RF power strength status of the transmitter for warning the PCD's user of high RF radiation. The method include the following steps

(b) Pre-set a warning level for the transmitted RF power strength as shown in step 602, for example, in dBm scale, generally a GSM handset emitted RF radiation with a power range from −5 to 33 dBm. FIG. 5 is a graph of setting a warning level for, the transmitted RF power strength of the third embodiment in the present invention. In this example, we set 10 dBm as the pre-set warning level.

(c) Detect the TSS level shown in step 604.

(d) If the TSS level is great than warning level, then execute the step (d), else execute step (b) shown in step 606.

(e) Output the TSS level to the indicating device shown in step 608.

The present invention is not only apply to cellular phone, but also can be used in other personal communication devices to indicate TSS.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the accorded the broadest interpretation so as to ions and similar arrangements.

What is claimed is:

1. A radio communication device having a transmitter for emitting a radio signal to a corresponding receiver, the radio communication device comprising:
an indicating means for indicating a TSSI (transmitted signal strength indication) of the radio signal generated by the transmitter; and
a controller for detecting the TSSI and outputting the TSSI to the indicating means, the controller including:
a transmitted power detecting means coupled to the transmitter for detecting a TSS (transmitted Signal Strength) level of the radio signal emitted from the transmitter to the corresponding receiver.

2. The radio communication device as claimed in claim 1, wherein the transmitted power detecting means further comprises a TSS (transmitted Signal Strength) detector coupled to a point of a conducting line disposed between a low pass filter coupled to a antenna of the radio communication device and a power amplifier of the transmitter for detecting the TSS level of the radio signal of the transmitter.

3. The radio communication device as claimed in claim 2, wherein the TSS detector further comprises a RC oscillation circuit coupled to a diode for detecting the TSS level of the radio signal of the transmitter.

4. The radio communication device as claimed in claim 1, wherein the transmitted power detecting means further comprises a TSS detector coupled to a power amplifier of the transmitter for detecting the DC offset of the power amplifier of the transmitter corresponding to the TSS (transmitted signal strength) of the transmitter.

5. The radio communication device as claimed in claim 4, wherein the TSS detector further comprises a resistor coupled to the operation amplifier having two terminals, the resistor have two terminals, one terminal of the resistor coupled to the power amplifier and one terminal of the operational amplifier, the other terminal of the resistor coupled to the other terminal of the operational amplifier and a power voltage source for determining the DC voltage difference between the two terminal of the resistor corresponding to the TSS (transmitted signal strength).

6. The radio communication device as claimed in claim 1, wherein the indicating means further comprises a display for displaying the TSS level.

7. The radio communication device as claimed in claim 1, wherein the indicating means further comprises a speaker for indicating the TSS level by sounds or voices.

8. The radio communication device as claimed in claim 1, wherein the indicating means further comprises a vibrator for indicating the TSS level by vibration.

9. The radio communication device as claimed in claim 1, wherein the indicating means further comprises a smell generator for indicating the TSS level by a smell.

10. A PCD (Personal Communication Device) with a transmitter which emitted a RF signal to a corresponding receiver, comprising
an indicating means for indicating a TSSI (transmitted signal strength indication) of the radio signal generated by the transmitter;
a transmitted power detecting means coupled to the transmitter for detecting a TSSI (transmitted signal strength) level of the radio signal emitted from the transmitter to the corresponding receiver; and
a controller coupled to the indicating means and the power detecting means for receiving the TSSI from the power detecting means and outputting the TSSI to the indicating means.

11. The PCD as claimed in claim 10, wherein the transmitted power detecting means further comprises a TSS detector coupled to a point of a conducting line disposed between a low pass filter coupled to a antenna of the PCD and a power amplifier of the transmitter for detecting the TSS level of the transmitter and outputting the detecting result to the controller.

12. The PCD as claimed in claim 11, wherein the TSS detector further comprises a RC oscillation circuit coupled to a diode for detecting the TSS level of the radio signal of the transmitter.

13. The PCD as claimed in claim 10, wherein the transmitted power detecting means further comprises a TSS detector coupled to a power amplifier of the transmitter for detecting a DC offset of the power amplifier of the transmitter corresponding to the TSS (transmitted signal strength) of the transmitter.

14. The PCD as claimed in claim 13, wherein the TSS detector further comprises a resistor coupled to the operation amplifier having two terminals, the resistor have two terminals, one terminal of the resistor coupled to the power amplifier and one terminal of the operational amplifier, the other terminal of the resistor coupled to the other terminal of the operational amplifier and a power voltage source for determining the DC voltage difference between the two terminal of the resistor corresponding to the TSS (transmitted signal strength).

15. The PCD as claimed in claim 10, wherein the indicating means further comprises a display for displaying the TSS level.

16. The PCD as claimed in claim 10, wherein the indicating means further comprises a speaker for indicating the TSS level by sounds or voices.

17. The PCD as claimed in claim 10, wherein the indicating means further comprises a vibrator for indicating the TSS level by vibration.

18. The PCD as claimed in claim 10, wherein the indicating means further comprises a smell generator for indicating the TSS level by a smell.

19. A method for warning a PCD's user of high RY radiation, the PCD having an indicating means for indicating a transmitted RF power strength of a transmitter of the PCD and a power detecting means for detecting the transmitted RF power of the transmitter, the method including the following steps:
(a) Pre-setting a warning level for the transmitted RF power strength;
(b) Detecting the TSS level by the power detecting means;
(c) executing the step (d) if the TSS level is great than warning level, else executing step (b); and
(f) Outputting the TSS level to the indicating means.
